(19) United States
(12) Patent Application Publication
(10) Pub. No.: US 2018/0374101 A1
(43) Pub. Date: Dec. 27, 2018

(54) FACIAL BIOMETRICS CARD EMULATION FOR IN-STORE PAYMENT AUTHORIZATION

(71) Applicant: SAFFE LTD, London (GB)

(72) Inventors: Andre Aranha Coelho, Sao Pualo (BR); Giovani Chiachia, Duelmen (DE)

(21) Appl. No.: 16/015,992

(22) Filed: Jun. 22, 2018

Related U.S. Application Data
(60) Provisional application No. 62/524,167, filed on Jun. 23, 2017.

(51) Int. Cl. G06Q 20/40; G06K 9/00

(52) U.S. Cl. CPC G06Q 20/40145; G06K 9/00288; G06Q 20/4012

(57) ABSTRACT

A method of in-store authorization of a payment transaction includes configuring a database to store a payment card emulator for a consumer including a reference facial image of the consumer bound with payment card information for a physical payment card of the consumer. A first request to authorize the payment transaction is received from a mobile device equipped with a camera, including a payment amount, an image captured by the camera, and a string of characters. The database and the payment card emulator stored therein are accessed, and automated face recognition with liveness detection is performed using the reference facial image to determine if the image is the consumer's authentic facial image. A second request to authorize the payment transaction is sent to a financial institution computer to authorize or decline the transaction, including the payment amount and the payment card information for the physical payment card.

### CROSS-REFERENCE TO RELATED APPLICATION(S)

The present application claims priority to U.S. Provisional Patent Application No. 62/524,167, entitled: Facial Biometrics Card Emulation for In-Store Payment Authorization, filed on Jun. 23, 2017, the content of which is incorporated herein by reference in its entirety.

### TECHNOLOGICAL FIELD

The present disclosure relates generally to payment authorization and, in particular, to in-store payment authorization using facial biometrics card emulation.

### BACKGROUND

The incorporation of mobile devices in payment processes at the point-of-sale is allowing consumers and merchants to experiment with unconventional ways of authorizing payments. On the merchant side, for example, there have been developments that allow merchants to integrate a lower-cost card reader device into their existing mobile device to accept payments through such combination of devices. On the consumer side, for example, there have been developments of solutions allowing consumers to emulate traditional payments methods (e.g., debit and credit cards) directly in their mobile devices, therefore replacing the physical cards by such devices.

While the value of such developments can be perceived by both merchants and consumers, from a user experience perspective, the advances are arguably subtle. In the first example, the merchant still needs a specialized hardware to communicate with the card or the card emulator (e.g., mobile device, bracelet, etc.). In the second example, the consumer still needs to have a functional piece of hardware (e.g., mobile device, bracelet, etc.) to emulate the card in order to carry out the authentication process.

Therefore, it would be desirable to have a system and method that takes into account at least some of the issues discussed above, as well as other possible issues.

### BRIEF SUMMARY

In view of the foregoing background, example implementations of the present disclosure are directed to in-store, point of sale (POS) payment authorization relying on automatic facial recognition to emulate payment cards directly in the consumer, binding the appearance of their faces to the relevant information for authorization of their payment methods (e.g., card number, security information, etc.), with the ultimate goal of allowing consumers to pay without any belongings, effectively replacing payment cards by the consumers' faces.

The present disclosure thus includes, without limitation, the following example implementations.

Some example implementations provide a method of authorization of a point of sale (POS) payment transaction, the method comprising configuring a database to store payment card emulators for consumers, of which a payment card emulator for a consumer includes a reference facial image of the consumer bound with payment card information for a physical payment card of the consumer; receiving a first request to authorize the POS payment transaction from a mobile device equipped with a camera, the first request including a payment amount, an image captured by the camera, and a string of characters, and excluding the payment card information for the physical payment card or any other payment card; accessing the database and the payment card emulator stored therein; performing automated face recognition with liveness detection using the reference facial image to determine if the image captured by the camera is an authentic facial image of the consumer; and only when the automated face recognition with liveness detection indicates the image captured by the camera is an authentic facial image of the consumer, sending a second request to authorize the POS payment transaction to a financial institution computer, the second request including, and being sent to enable the financial institution computer to authorize or decline the POS payment transaction using the payment amount and the payment card information for the physical payment card; and receiving a response from the financial institution that indicates the POS payment transaction is approved or denied, and sending the response to the mobile device.

In some example implementations of the method of any preceding example implementation, or any combination of any preceding example implementations, configuring the database includes configuring the database to store the reference facial image of the consumer bound with payment card information that includes at least a card number and security information for the physical payment card.

In some example implementations of the method of any preceding example implementation, or any combination of any preceding example implementations, the database is further configured to store a personal identification number (PIN) attributed to the consumer, and receiving the request includes receiving the request further including a string of characters, and wherein the method further comprises determining if the string of characters matches the PIN, the second request being sent only when both the image captured by the camera is an authentic facial image of the consumer, and the string of characters matches the PIN.

In some example implementations of the method of any preceding example implementation, or any combination of any preceding example implementations, the method further comprises sending a response to the mobile device that indicates the POS payment transaction is denied when the automated face recognition with liveness detection indicates the image captured by the camera is not an authentic facial image of the consumer.

Some example implementations provide an apparatus for authorization of a POS payment transaction. The apparatus comprises a memory configured to store computer-readable program code; and a processor configured to access the memory, and execute the computer-readable program code to cause the apparatus to at least perform the method of any preceding example implementation, or any combination of any preceding example implementations.

Some example implementations provide a computer-readable storage medium for authorization of a POS payment transaction. The computer-readable storage medium is non-transitory and having computer-readable program code stored therein that in response to execution by a processor, causes an apparatus to at least perform the method of any preceding example implementation, or any combination of any preceding example implementations.

Features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

### BRIEF DESCRIPTION OF THE FIGURES(S)

Having thus described the disclosure in general terms, reference will now be made to the accompanying figures, which are not necessarily drawn to scale, and wherein:

FIG. 1 illustrates a system according to example implementations of the present disclosure;

FIG. 2 illustrates a card emulation process, according to some example implementations;

FIG. 3 illustrates in-store, point of sale (POS) payment with facial biometrics card emulation, according to some example implementations;

FIG. 4 is a flowchart illustrating various steps in a method of configuring a facial recognition-based card emulator, according to some example implementations;

FIG. 5 is a flowchart illustrating various steps in a method of utilizing a facial recognition-based card emulator for in-store, POS payment authentication, according to some example implementations;

FIG. 6 is a flowchart illustrating various steps in a method of generating a facial-recognition-based card emulator, according to some example implementations;

FIG. 7 is a flowchart illustrating various steps in a method of instantiating a facial-recognition-based card emulator, according to some example implementations; and

FIG. 8 illustrates an apparatus according to example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. As used herein, for example, the singular forms “a,” “an,” “the” and the like include plural referents unless the context clearly dictates otherwise. The terms “data,” “information,” “content” and similar terms may be used interchangeably, according to some example implementations of the present invention, to refer to data capable of being transmitted, received, operated on, and/or stored. Also, for example, reference may be made herein to quantitative measures, values, relationships or the like. Unless otherwise stated, any one or more if not all of these may be absolute or approximate to account for acceptable variations that may occur, such as those due to engineering tolerances or the like. Like reference numerals refer to like elements throughout.

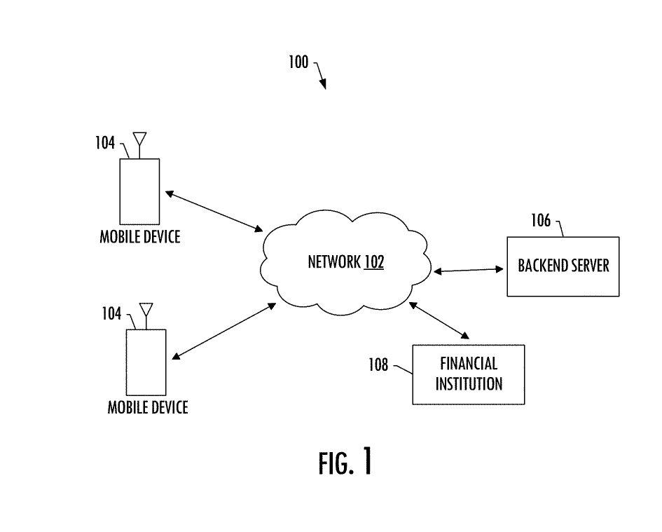

FIG. 1 illustrates a system 100 according to example implementations of the present disclosure. As shown, the system may be implemented with an Internet-based computing architecture including a computer network or a number of interconnected computer networks 102 in or over which a number of systems, computers and the like communicate or otherwise operate. As shown, these include mobile devices 104, a backend server 106 and a financial institution server 108.

Although shown and described herein in the context of an Internet-based computing architecture, it should be understood that the system may implemented with any of a number of different network-based architectures.

The network 102 may be implemented as one or more wired networks, wireless networks or some combination of wired and wireless networks. The network may include private, public, academic, business or government networks, or any of a number of different combinations thereof, and in the context of an Internet-based computing architecture, includes the Internet. The network may support one or more of any of a number of different communications protocols, technologies or the like, such as cellular telephone, Wi-Fi, satellite, cable, digital subscriber line (DSL), fiber optics and the like.

The systems and computers connected to the network 102 may also be implemented in a number of different manners. The mobile device 104 is generally a small, mobile computing device such as a smartphone. Other examples of suitable mobile devices include portable computers (e.g., laptop computers, tablet computers), cellular phones, wearable computers (e.g., smartwatches, optical head-mounted displays) and the like. According to example implementations, the mobile device includes one or more cameras configured to capture images such as self-portrait images (more commonly known as selfies).

The backend server 106 and the financial institution server 108 are each commonly implemented as a server computer although other implementations are contemplated (e.g., mainframe computer, personal computer). Either or both of the backend server and the financial institution server may be embodied as one or more servers, a network of interworking computing devices (e.g., a distributed computer implemented by multiple computers) or the like. In implementations in which the server is implemented as a distributed computer, its multiple computers may communicate over a network such as network 102. And in some examples, the backend server and the financial institution server are co-located.

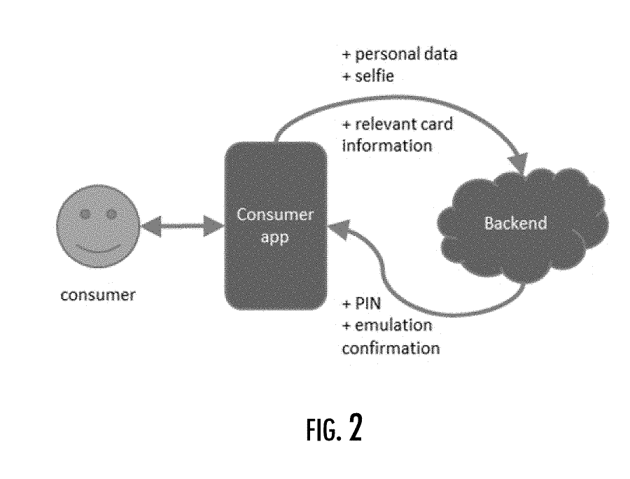

Some example implementations of the present disclosure include a mobile app for a mobile device 104 that enables facial biometrics card emulation, and that operates connected to the backend server 106, which is configured to process and store information. As shown in FIG. 2, as part of the emulation process, a consumer initially:
1. Downloads and installs the mobile app on their mobile device;
2. Enters personal data;
3. Takes a selfie to serve as the secure element of the initial emulator of her/his payment cards;
4. Upon approval of the authenticity of all provided information, the consumer
   a. Attributes or is attributed a personal identification number (PIN);
   b. Registers, for each card to be emulated, the relevant information for emulation. This may include, for example, the card number, and any security information such as an expiration date, card security code and the like.
      The backend server configures a database to store payment card emulators for consumers. The payment card emulator for the consumer includes the selfie that serves as the secure element (a reference facial image of the consumer) bound with payment card information for the physical payment card of the consumer.

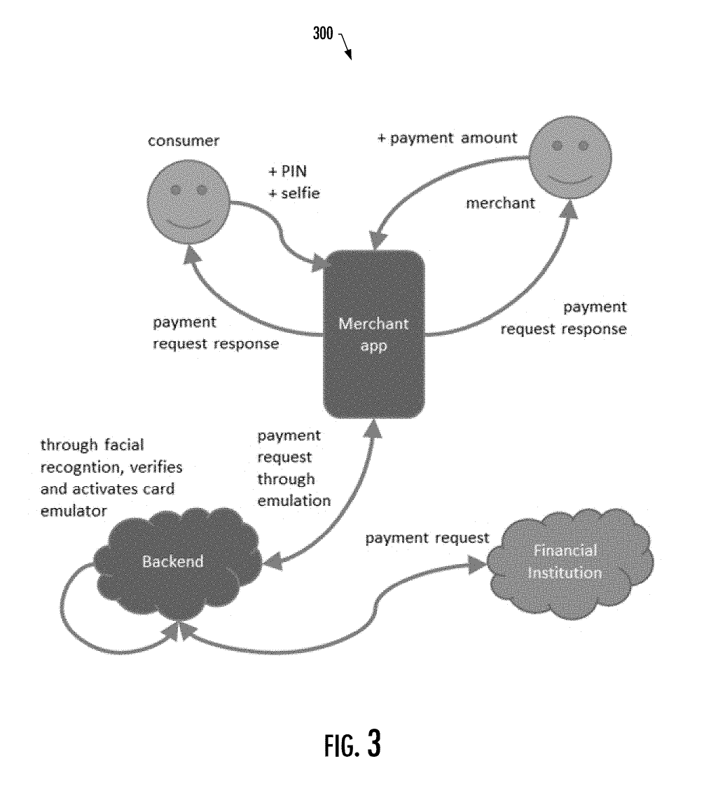

Once the consumer has gone through the initial registration process for facial biometrics card emulation, she/he can rely on the network of merchants that accepts payments via this technology to make payments and, therefore, effectively perform the emulation. As shown in FIG. 3, at the point-of-the sale, the process 300 in some examples includes the following steps:

| Consumer | Merchant |
|---|---|
| 1. Tells the merchant she/he wants | |
| to pay through the system; | |
| | 2. Through the mobile app in her/his |
| | mobile device, enters the payment |
| | amount; |
| | 3. Hands her/his mobile device to the |
| | consumer; |
| 4. Enters her/his PIN code into the | |
| merchant's mobile device; | |
| 5. Takes a selfie; | |
| 6. Submits the payment for | |
| approval; | |
| 7. After processing, attests the | |
| response of the payment | |
| authorization request (e.g., | |
| approval, denial, etc.); | |
| 8. Hands the device back to the | |
| merchant; | |
| | 9. Attests the response of the |
| | payment authorization request. |

From the steps described above, example implementations of the present disclosure can precisely be seen as a replacement of the physical card by the facial biometrics (through the selfie) in the standard process that requires the consumer to have her/his physical card in possession, as well as the PIN, for submission of the payment authorization request.

At the backend server 106, a payment authorization request takes the selfie and the PIN and, through automated face recognition with liveness detection (a combination of facial recognition and facial fraud detection), attests for the validity of the card emulation and proceeds with the payment approval of the attempted payment amount in the relevant financial institution server 108. Automated face recognition enables the backend server to verify the customer in the selfie. Liveness detection is at times referred to as facial fraud detection, human detection, face liveness detection, facial biometrics spoofing detection and the like. It enables the backend server to determine if the selfie registers the presence of a real or live human, or a fake or not live human as may be the case for an image that is itself of another image, video, mask or the like, of a human not present during image capture.

The backend server 106 may be configured to perform face recognition and liveness detection in any of a number of different manners and with either being performed before the other. In some examples, face recognition is performed using artificial neural networks that extract feature vectors directly from an image and compare (via distance metrics) such feature vectors with feature vectors in a reference image stored in a database of the backend server. Similarly, in some examples, liveness detection is performed using artificial neural networks that extract feature vectors directly from an image and project such feature vectors onto a hyperplane in order to arbitrate whether or not an image or sequence of images convey the presence of a living human. Examples of suitable techniques are further described in G. Chiachia et al., “Learning Person-Specific Representations From Faces in the Wild,” in IEEE Transactions on Information Forensics and Security, vol. 9, no. 12, pp. 2089-2099, December 2014; and D. Menotti et al., “Deep Representations for Iris, Face, and Fingerprint Spoofing Detection,” in IEEE Transactions on Information Forensics and Security, vol. 10, no. 4, pp. 864-879, April 2015, the contents of which are incorporated herein by reference in their entireties.

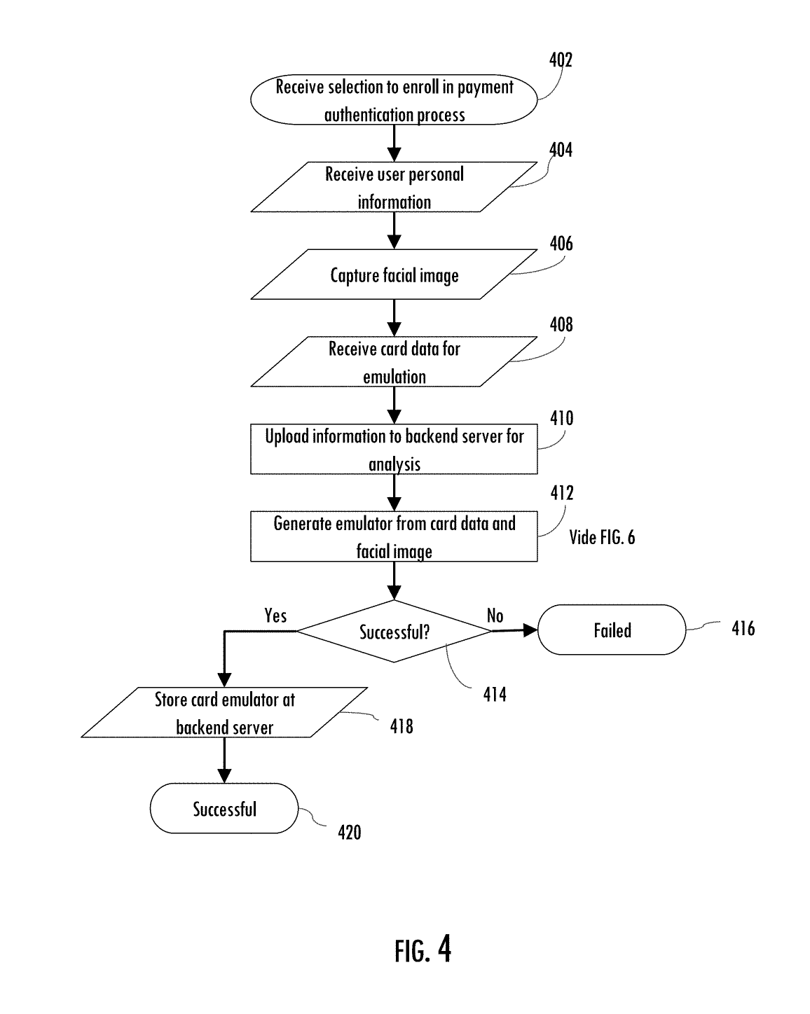

FIG. 4 illustrates the configuration of a new user in the process of facial recognition-based card emulation, according to some example implementations. As shown at 402, the method is started by the consumer and is carried out entirely at the consumer's mobile device 104. The method includes the consumer providing personal information, such as name, birth date, address, etc., as shown at 404. The system captures the consumer's facial image using the camera of the device and asks the consumer to provide information of the payment card to be emulated, as shown at 406, 408. The system then uploads the collected information to the backend server 106 at which generation of the facial recognition-based card emulator is attempted, as shown at 410, 412. If unsuccessful, the process finishes as failed, as shown at 414, 416; otherwise, if successful, the generated card emulator is stored in a database at the backend server for later use and the process finishes as successful, as shown at 414, 418, 420.

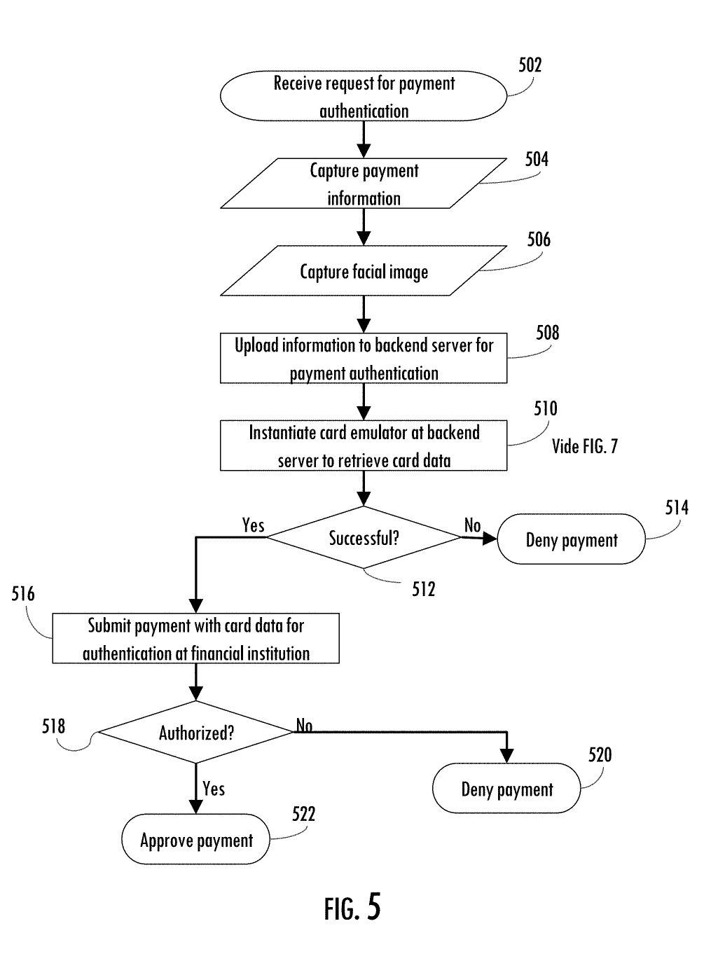

FIG. 5 illustrates the use of the facial recognition-based card emulator to authenticate in-store, point of sale (POS) payments, according to some example implementations. As shown at 502, the method is started by the merchant user and is carried out entirely at the merchant's mobile device 104. The method includes the merchant informing the payment information, such as the value, as shown at 504. The consumer can also here provide payment information, such as a PIN number. As shown at 506, the system captures the consumer's facial image using the camera of the mobile device. As shown at 508, 510, the system uploads the collected information to the backend server 106, where instantiation of the facial recognition-based card emulator is attempted. If unsuccessful, the process finishes as failed, as shown at 512, 514. If successful, card data is retrieved from the card emulator and the payment is submitted to the financial institution server 108 for authorization, as shown at 516. If not authorized at the financial institution, the payment is denied, as shown at 518, 520. If authorized, the payment is approved, as shown at 518, 522.

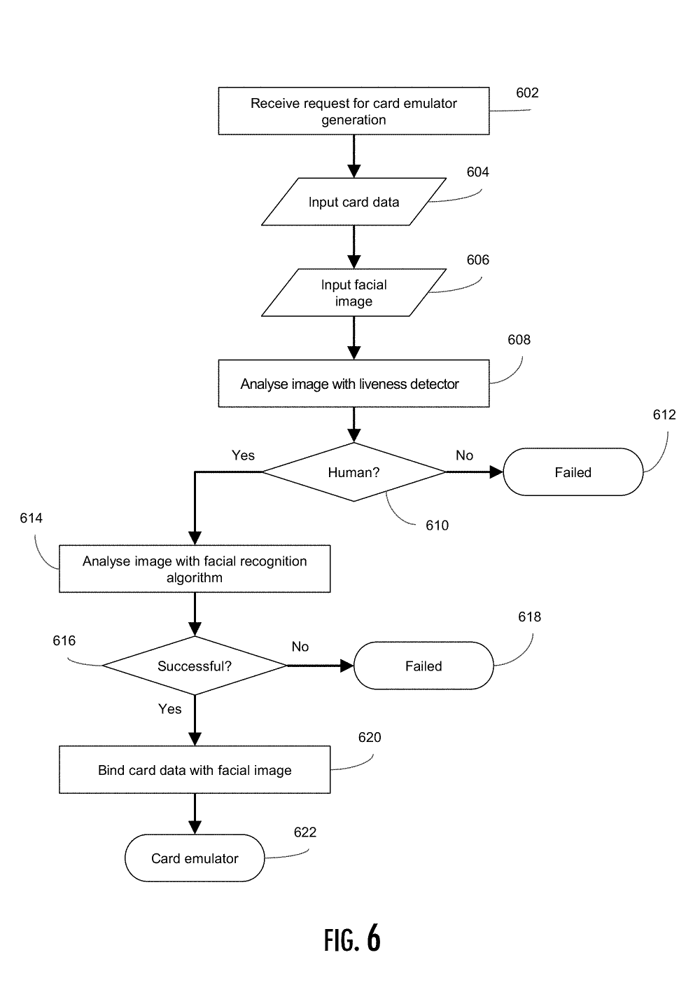

FIG. 6 illustrates how a facial recognition-based card emulator is generated, according to some example implementations. Upon the request for generation of a new emulator, the method includes retrieving card data and facial image as input information, as shown at 602, 604, 606. The facial image is then submitted to an automated liveness detector (automatic human detector) to determine the presence of a human user in the image being used to generate the emulator, as shown at 608. If the presence of a human user is not detected, the process is finished as failed, as shown at 610, 612. If the presence of a human user is detected, the system submits the facial image for analysis by a facial recognition algorithm to assert that the facial image is appropriate for use in the emulation of cards, as shown at 610, 614. If the analysis is not successful, the process finishes as failed, as shown at 616, 618. If the analysis is successful, card data and facial images are bound and a card emulator from this binding is created and returned, as shown at 616, 620, 622.

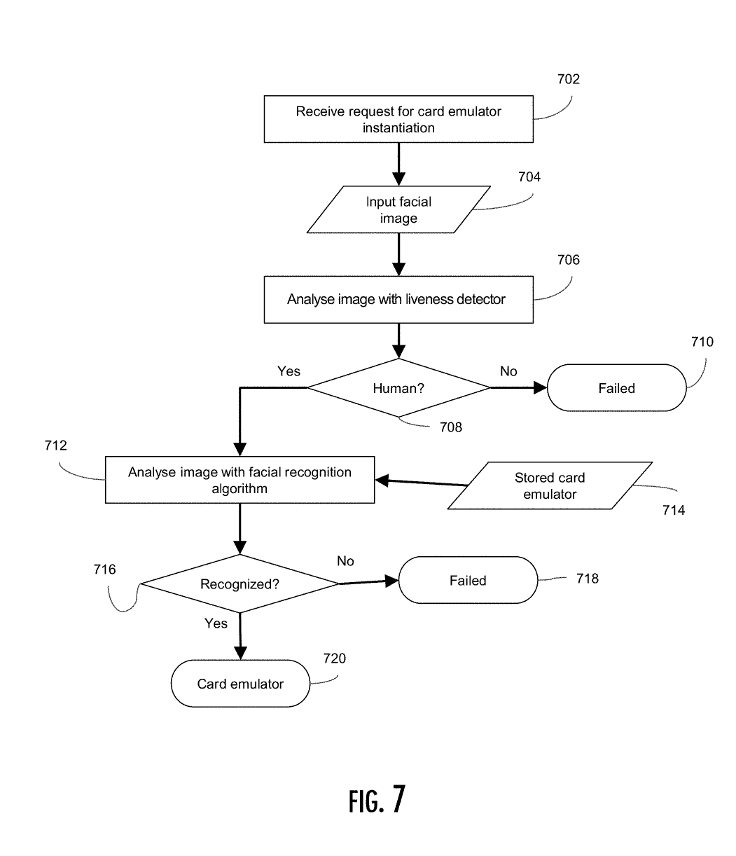

FIG. 7 illustrates the instantiation of a card emulator, according to some example implementations. Upon request for instantiation, the method includes retrieval of the facial image as input information, as shown at 702, 704. This facial image is then submitted to an automated liveness detector (automatic human detector) to determine the presence of a human user in the image being used to instantiate the emulator, as shown at 706. If the presence of a human user is not detected, the process is finished as failed, as shown at 708, 710. If the presence of a human user is detected, the system submits the facial image for analysis by a facial recognition algorithm which in turn attempts to recognize the user in the input facial image by retrieving the relevant card emulator(s) and comparing their corresponding facial image(s) with the input facial image, as shown at 708, 712, 714. If the user in the input facial image is not recognized, the process finished as failed, as shown at 716, 718. If the user in the input facial image is recognized, the card emulator is instantiated and returned, as shown at 716, 720.

According to example implementations of the present disclosure, the system 100 and its subsystems including the mobile devices 104, backend server 106 and financial institution server 108 may be implemented by various means. Means for implementing the system and its subsystems may include hardware, alone or under direction of one or more computer programs from a computer-readable storage medium. In some examples, one or more apparatuses may be configured to function as or otherwise implement the system and its subsystems shown and described herein. In examples involving more than one apparatus, the respective apparatuses may be connected to or otherwise in communication with one another in a number of different manners, such as directly or indirectly via a wired or wireless network or the like.

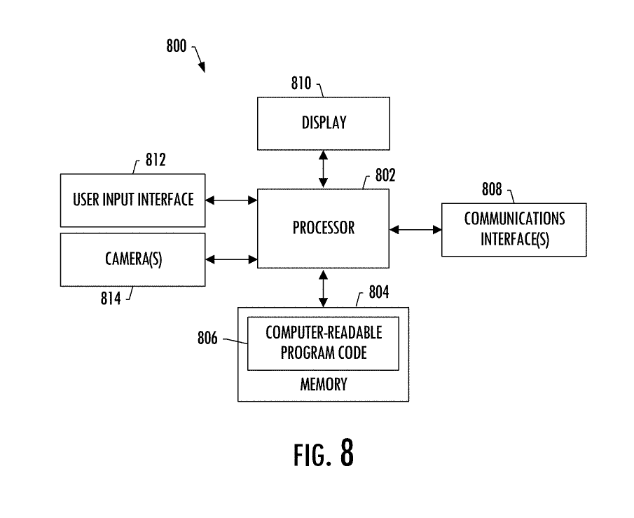

FIG. 8 illustrates an apparatus 800 according to some example implementations of the present disclosure. Generally, an apparatus of exemplary implementations of the present disclosure may comprise, include or be embodied in one or more fixed or portable electronic devices. The apparatus may include one or more of each of a number of components such as, for example, a processor 802 connected to a memory 804 (e.g., storage device).

The processor 802 may be composed of one or more processors alone or in combination with one or more memories. The processor is generally any piece of computer hardware that is capable of processing information such as, for example, data, computer programs and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 804 (of the same or another apparatus).

The processor 802 may be a number of processors, a multi-core processor or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more ASICs, FPGAs or the like. Thus, although the processor may be capable of executing a computer program to perform one or more functions, the processor of various examples may be capable of performing one or more functions without the aid of a computer program. In either instance, the processor may be appropriately programmed to perform functions or operations according to example implementations of the present disclosure.

The memory 804 is generally any piece of computer hardware that is capable of storing information such as, for example, data, computer programs (e.g., computer-readable program code 806) and/or other suitable information either on a temporary basis and/or a permanent basis. According to example implementations, this may include one or more mobile apps. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 804, the processor 802 may also be connected to one or more interfaces for displaying, transmitting and/or receiving information. The interfaces may include one or more communications interfaces and/or one or more user interfaces. The communications interface(s) may be configured to transmit and/or receive information, such as to and/or from other apparatus(es), network(s) or the like. The communications interface may be configured to transmit and/or receive information by physical (wired) and/or wireless communications links. The communications interface(s) may include interface(s) 808 to connect to a network (e.g., network 102), such as using technologies such as cellular telephone, Wi-Fi, satellite, cable, digital subscriber line (DSL), fiber optics and the like. And at least in instances in which the apparatus 800 is configured to implement the mobile device 104, the communications interface(s) may include one or more short-range communications interfaces configured to connect devices using short-range communications technologies such as NFC, RFID, Bluetooth, Bluetooth LE, ZigBee, infrared (e.g., IrDA) or the like.

The user interfaces may include a display 810 and/or one or more user input interfaces 812. The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen) or the like. In instances in which the apparatus 800 is configured to implement the mobile device 104, the user interfaces may include one or more cameras 814 capable of capturing images. The user interfaces may further include one or more interfaces for communicating with peripherals such as printers, scanners or the like.

As indicated above, program code instructions may be stored in memory, and executed by processor that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by processor, or storage of instructions in a computer-readable storage medium, supports combinations of operations for performing the specified functions. In this manner, an apparatus 800 may include processor 802 and a computer-readable storage medium or memory 804 coupled to the processor, where the processor is configured to execute computer-readable program code 806 stored in the memory. It will also be understood that one or more functions, and combinations of functions, may be implemented by special purpose hardware-based computer systems and/or processor which perform the specified functions, or combinations of special purpose hardware and program code instructions.

As explained above, the present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for authorization of a point of sale (POS) payment transaction, the apparatus comprising:
a memory configured to store computer-readable program code; and
a processor configured to access the memory, and execute the computer-readable program code to cause the apparatus to at least:
configure a database to store payment card emulators for consumers, of which a payment card emulator for a consumer includes a reference facial image of the consumer bound with payment card information for a physical payment card of the consumer;
receive a first request to authorize the POS payment transaction from a mobile device equipped with a camera, the first request including a payment amount, an image captured by the camera, and a string of characters, and excluding the payment card information for the physical payment card or any other payment card;
access the database and the payment card emulator stored therein;
perform automated face recognition with liveness detection using the reference facial image to determine if the image captured by the camera is an authentic facial image of the consumer; and only when the automated face recognition with liveness detection indicates the image captured by the camera is an authentic facial image of the consumer,
send a second request to authorize the POS payment transaction to a financial institution computer, the second request including, and being sent to enable the financial institution computer to authorize or decline the POS payment transaction using the payment amount and the payment card information for the physical payment card; and
receive a response from the financial institution that indicates the POS payment transaction is approved or denied, and send the response to the mobile device.

2. The apparatus of claim 1, wherein the apparatus being caused to configure the database includes being caused to configure the database to store the reference facial image of the consumer bound with payment card information that includes at least a card number and security information for the physical payment card.

3. The apparatus of claim 1, wherein the database is further configured to store a personal identification number (PIN) attributed to the consumer, and the apparatus being caused to receive the request includes being caused to receive the request further including a string of characters, and
wherein the processor is configured to execute the computer-readable program code to cause the apparatus to further determine if the string of characters matches the PIN, the apparatus being caused to send the second request only when both the image captured by the camera is an authentic facial image of the consumer, and the string of characters matches the PIN.

4. The apparatus of claim 1, wherein the processor is configured to execute the computer-readable program code to cause the apparatus to further send a response to the mobile device that indicates the POS payment transaction is denied when the automated face recognition with liveness detection indicates the image captured by the camera is not an authentic facial image of the consumer.

5. A method of authorization of a point of sale (POS) payment transaction, the method comprising:
configuring a database to store payment card emulators for consumers, of which a payment card emulator for a consumer includes a reference facial image of the consumer bound with payment card information for a physical payment card of the consumer;
receiving a first request to authorize the POS payment transaction from a mobile device equipped with a camera, the first request including a payment amount, an image captured by the camera, and a string of characters, and excluding the payment card information for the physical payment card or any other payment card;
accessing the database and the payment card emulator stored therein;
performing automated face recognition with liveness detection using the reference facial image to determine if the image captured by the camera is an authentic facial image of the consumer; and only when the automated face recognition with liveness detection indicates the image captured by the camera is an authentic facial image of the consumer,
sending a second request to authorize the POS payment transaction to a financial institution computer, the second request including, and being sent to enable the financial institution computer to authorize or decline the POS payment transaction using the payment amount and the payment card information for the physical payment card; and
receiving a response from the financial institution that indicates the POS payment transaction is approved or denied, and sending the response to the mobile device.

6. The method of claim 5, wherein configuring the database includes configuring the database to store the reference facial image of the consumer bound with payment card information that includes at least a card number and security information for the physical payment card.

7. The method of claim 5, wherein the database is further configured to store a personal identification number (PIN) attributed to the consumer, and receiving the request includes receiving the request further including a string of characters, and
wherein the method further comprises determining if the string of characters matches the PIN, the second request being sent only when both the image captured by the camera is an authentic facial image of the consumer, and the string of characters matches the PIN.

8. The method of claim 5 further comprising sending a response to the mobile device that indicates the POS payment transaction is denied when the automated face recognition with liveness detection indicates the image captured by the camera is not an authentic facial image of the consumer.

9. A computer-readable storage medium for authorization of a point of sale (POS) payment transaction, the computer-readable storage medium being non-transitory and having computer-readable program code stored therein that in response to execution by a processor, causes an apparatus to at least:
configure a database to store payment card emulators for consumers, of which a payment card emulator for a consumer includes a reference facial image of the consumer bound with payment card information for a physical payment card of the consumer;
receive a first request to authorize the POS payment transaction from a mobile device equipped with a camera, the first request including a payment amount, an image captured by the camera, and a string of characters, and excluding the payment card information for the physical payment card or any other payment card;
access the database and the payment card emulator stored therein;
perform automated face recognition with liveness detection using the reference facial image to determine if the image captured by the camera is an authentic facial image of the consumer; and only when the automated face recognition with liveness detection indicates the image captured by the camera is an authentic facial image of the consumer,
send a second request to authorize the POS payment transaction to a financial institution computer, the second request including, and being sent to enable the financial institution computer to authorize or decline the POS payment transaction using the payment amount and the payment card information for the physical payment card; and
receive a response from the financial institution that indicates the POS payment transaction is approved or denied, and send the response to the mobile device.

10. The computer-readable storage medium of claim 9, wherein the apparatus being caused to configure the database includes being caused to configure the database to store the reference facial image of the consumer bound with payment card information that includes at least a card number and security information for the physical payment card.

11. The computer-readable storage medium of claim 9, wherein the database is further configured to store a personal identification number (PIN) attributed to the consumer, and the apparatus being caused to receive the request includes being caused to receive the request further including a string of characters, and
wherein the computer-readable storage medium has computer-readable program code stored therein that in response to execution by the processor, causes the apparatus to further determine if the string of characters matches the PIN, the apparatus being caused to send the second request only when both the image captured by the camera is an authentic facial image of the consumer, and the string of characters matches the PIN.

12. The computer-readable storage medium of claim 9, wherein the computer-readable storage medium has computer-readable program code stored therein that in response to execution by the processor, causes the apparatus to further send a response to the mobile device that indicates the POS payment transaction is denied when the automated face recognition with liveness detection indicates the image captured by the camera is not an authentic facial image of the consumer.
